(19) United States
(12) Patent Application Publication
(10) Pub. No.: US 2016/0060883 A1
(43) Pub. Date: Mar. 3, 2016

(54) DEVICE FOR CONTROLLING THE SPACING BETWEEN SIDING MATERIALS AND COMPRESSIBLE INSULATION MATERIALS

(71) Applicants: CHRISTOPHER E. FETTERMAN, RICHMOND, VA (US); WAZIR NOBBEE, CHESTERFIELD, VA (US)

(72) Inventors: CHRISTOPHER E. FETTERMAN, RICHMOND, VA (US); WAZIR NOBBEE, CHESTERFIELD, VA (US)

(73) Assignee: E I DU PONT DE NEMOURS AND COMPANY, Wilmington, DE (US)

(21) Appl. No.: 14/817,280

(22) Filed: Aug. 4, 2015

Related U.S. Application Data
(60) Provisional application No. 62/042,880, filed on Aug. 28, 2014.

(51) Int. Cl. E04F 21/00; G01B 5/14; E04B 1/76

(52) U.S. Cl. CPC E04F 21/00; E04B 1/762; G01B 5/14

(57) ABSTRACT

A spacing device and a method for installing siding materials over Tyvek® ThermaWrap™ R5.0 or any compressible insulating house wrap. The spacing device 100 allows cladding fasteners to be installed to the same depth which helps eliminate wavy siding installations.

### BACKGROUND OF THE INVENTION

1. Field of Invention

The invention is a device for controlling the spacing between siding materials and compressible insulation materials during installation of siding on a budding. The present invention further relates to a method of installing siding using the device.

2. Description of the Related Art

Compressible insulating materials that are installed between siding and sheathing are a challenge for a siding installer to secure all fasteners to the same depth to ensure that the siding does not have a wavy appearance. Furthermore, the insulating value of the compressible insulating materials depends upon trapped air spaces. Any installation device and method that leaves the compressible insulating material in a compressed state will decrease the trapped air space and reduce insulation value. There is a need for a device and method to economically install siding, clapboards, and the like over sheathing, with compressible insulation materials in between them, at a consistent spacing that does not compress the compressible insulating material.

Gauges and depth stops are known for installing siding, clapboards, and the like onto a building. Illustratively, United States Patent Application Publication 2011/0078972 to Schwarz. et al. discloses siding spacers that are generally cylindrical in shape, having a substantially circular front surface, and a substantially circular rear surface joined by a slightly tapered side wall, and an aperture from the front surface to the rear surface. The method for installing the spacer includes providing a spacer including an aperture, locating the spacer between an exterior face of the building sheathing and a rear face of the siding such that the aperture is aligned with a slot in the siding and the siding is spaced apart from the sheathing by the thickness of the spacer, and inserting a fastener through the slot and the aperture such that the fastener is embedded in the sheathing. This spacer and method is hampered by the uneconomical and labor intensive requirement to use numerous spacers which are permanently installed between the siding and sheathing. Furthermore, the spacer will permanently compress compressible insulating materials, when installed between siding materials and the compressible insulating materials.

In United States Patent Application Publication 2004/0020066A1 Morey discloses a siding revealer gauge used to facilitate the installation of siding materials installed in an overlapping fashion with a precise amount of overlap. The siding revealer gauge has a handle attached to a back surface, a level top surface, and a ledge protruding from a front surface. The gauge is used to set the amount of a lower row of siding material that shows after the upper row of siding materials are installed on top. This tool does not have means for setting the distance the siding materials are spaced away from the sheathing.

In an installation guide published by APEX Marketing on Apr. 1, 2013 entitled “APEX® Installation Instructions”, a tool is shown for use in installing Ultrex® siding. The tool will distribute the load of the nail impact to maintain the drainage cavity. However the publication cautions that the tool is for use when installing over rigid foam board and that for best installation practice it is not for use when installing siding over non-rigid products.

The referenced prior art does not meet the need for a device and method to economically install siding, clapboards, and the like over sheathing, with compressible insulation materials in between them, at a consistent spacing that does not compress the compressible insulating material.

### SUMMARY OF THE INVENTION

One embodiment of the invention is a spacer device for spacing a siding material away from a budding sheathing comprising a main body having two bifurcations with spacing between the bifurcations, and two registering tabs on an edge opposite the bifurcations.

Another embodiment of the invention is a method for installing siding material over building sheathing with compressible insulation material between the siding material and the sheathing comprising placing a spacing device comprised of a main body having two bifurcations with spacing between the bifurcations, and two registering tabs on an edge opposite the bifurcations between the siding material and the compressible insulation material; temporarily compressing the compressible insulation material; driving a fastener to the depth of the spacing device; and removing the spacing device.

### BRIEF DESCRIPTION OF THE DRAWINGS

FIG. 1 is a perspective view of the device for spacing siding materials and sheathing.

FIG. 2 is an view of the device of FIG. 1 being used to install siding.

### DETAILED DESCRIPTION OF THE PREFERRED EMBODIMENTS

The device and method of the present invention relate to siding, clapboards, facades and the like, herein referred to as siding materials. Siding materials are generally manufactured and sold in long strips, ranging from between four and twelve inches in height and between eight and eighteen feet in length. Siding materials are generally manufactured from a variety of materials including fiber cement, vinyl, wood, and composites. Siding material are available in various thicknesses from about five-sixteenths inch to one inch in thickness. Siding materials are typically installed by placing a first length of siding along the lowest point of a wall to be covered. A second strip of siding material is then installed above, or more commonly, partially overlapping the top edge of the first siding strip. Additional strips of siding material are sequentially added, each one installed above or partially overlapping the previous strip. When installing siding material, care must be taken to equally space the entire length of each strip with respect to the materials over which it is installed. Siding materials are typically installed over sheathing. More recently there is a trend to install a layer of thermal insulation over the sheathing and then installing the siding material over the thermal insulation. The thermal insulation may be in the form of batts or blankets of compressible materials, such as mineral wool or thermal blankets. Tyvek® ThermaWrap™ R5.0 from DuPont is an example of a thermal blanket made from compressible materials. The spacing between siding materials and sheathing must be at a consistent spacing that does not compress the compressible insulating material, as well as giving an unsightly appearance.

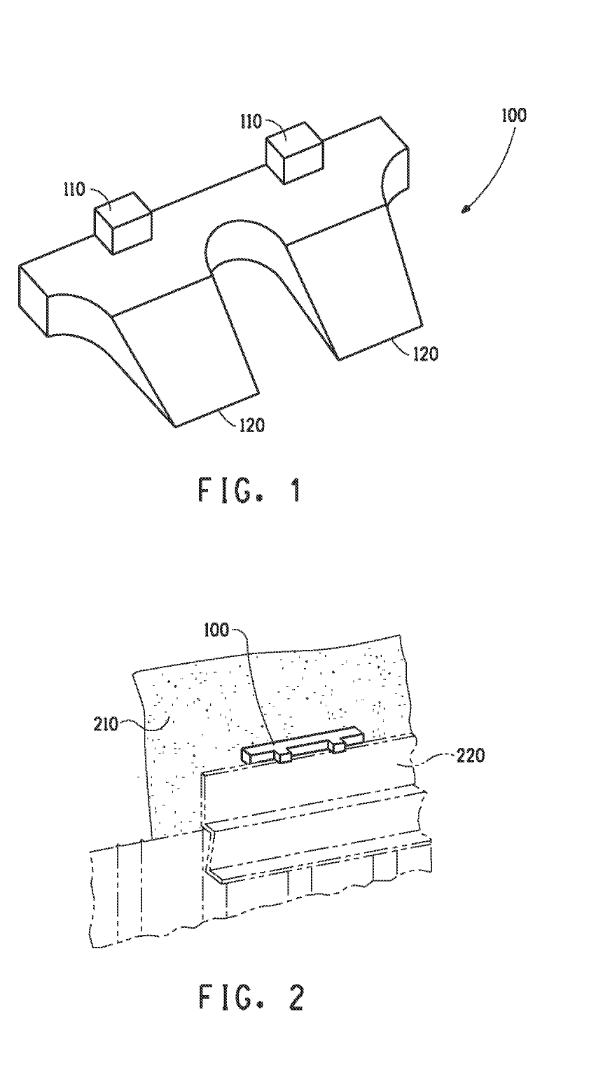

As illustrated in FIG. 1, the spacing device 100 comprises a main body having two bifurcations 120 with spacing between the bifurcations, and two registering tabs 110 on an edge opposite the bifurcations 120. The spacing device can be manufactured from any wood or plastic material, such as polyethylene, polypropylene, polyvinyl chloride, nylon, or a composite of these plastic aterials. Nylon is the preferred material of manufacture because of its durability. The thickness dimension of the spacing device is critical and is sized to match the thickness of the compressible insulation material to be installed. The other dimensions of the spacing device are not critical, but illustratively, it is found that dimensions on the order of 14 cm wide×7 cm tall are easy to handle and provide good results. The spacing device has space between the two bifurcations 120 that allows clearance for a fastener used to fasten siding materials to sheathing, and the spacing device to be removed after fastener installation. The two registering tabs 110 on the edge opposite the bifurcations 120 allow for the spacing device to rest on the top edge of siding materials while they are being installed.

In use, the spacing device 100 is placed between the siding material 220 and the compressible insulation material 210, as illustrated in FIG. 2. The spacing device 100 temporarily compresses compressible insulation material 220 as a fastener is installed to the depth of the spacing device 100. The spacing device 100 is removed and placed in the next fastener location. The compressible insulation material 210 thickness recovers after the spacing device 100 is removed. The spacing device 100 is designed to be removed and assist with the installation of fasteners along the entire piece of siding and at the ends at inside and outside corners and does not remain fastened in place.

What is claimed is:

1. A spacer device for spacing a siding material away from a building sheathing, the device comprising: a main body having two bifurcations 120 with spacing between the bifurcations, and two registering tabs 110 on an edge opposite the bifurcations 120.

2. A method for installing siding material over building sheathing with compressible insulation material between the siding material and the sheathing, the method comprising:
(a) placing the spacing device of claim 1 between the siding material and the compressible insulation material,
(b) temporarily compressing the compressible insulation material,
(c) driving a fastener to the depth of the spacing device, and
(d) removing the spacing device.
